(19) United States
(12) Patent Application Publication
(10) Pub. No.: US 2025/0184725 A1
(43) Pub. Date: Jun. 5, 2025

(54) CRYPTOGRAPHIC TECHNIQUES IN WIRELESS COMMUNICATION NETWORKS

(71) Applicant: Abhijeet Ashok Kolekar, Hillsboro, OR (US)

(72) Inventor: Abhijeet Ashok Kolekar, Hillsboro, OR (US)

(21) Appl. No.: 19/046,129

(22) Filed: Feb. 5, 2025

Related U.S. Application Data
(60) Provisional application No. 63/549,907, filed on Feb. 5, 2024.
(60) Provisional application No. 63/549,953, filed on Feb. 5, 2024.
(60) Provisional application No. 63/549,970, filed on Feb. 5, 2024.

(51) Int. Cl. H04W 12/043; H04W 8/22; H04W 12/06; H04W 60/04; H04W 76/15; H04W 76/19

(52) U.S. Cl. CPC H04W 12/043; H04W 8/22; H04W 12/06; H04W 60/04; H04W 76/15; H04W 76/19

(57) ABSTRACT

Systems and methods are disclosed for enhancing cryptographic security in 5G networks by addressing key management, algorithm selection, and security context consistency. One method ensures uniform cryptographic key lengths during Access and Mobility Function (AMF) changes, maintaining consistent Non-Access Stratum (NAS) security contexts across transitions. Another method focuses on dual connectivity scenarios, ensuring uniform cryptographic key lengths across Master Node and Secondary Node communications by defining a unified cryptographic profile and enhancing capability signaling. Additionally, an entropy-based approach to cryptographic algorithm selection is introduced, incorporating entropy assessment into the capability signaling process. This ensures that selected cryptographic algorithms for Access Stratum (AS) and NAS layers align with the actual entropy of long-term keys, providing true security levels.

### PRIORITY CLAIM

This application claims the benefit of priority to U.S. Provisional Patent Application Ser. No. 63/549,907, filed Feb. 5, 2024, U.S. Provisional Patent Application Ser. No. 63/549,953, filed Feb. 5, 2024, and U.S. Provisional Patent Application Ser. No. 63/549,970, filed Feb. 5, 2024, each of which is incorporated herein by reference in its entirety.

### TECHNICAL FIELD

Embodiments pertain to wireless networks and wireless communications. Some embodiments relate to cryptographic algorithms and key usage in wireless networks.

### BACKGROUND

Mobile communication has evolved significantly from early voice systems to highly sophisticated integrated communication platform. Next-generation (NG) wireless communication systems, including 5^{th} generation (5G) and sixth generation (6G) or new radio (NR) systems, are to provide access to information and sharing of data by various users (e.g., user equipment (UEs)) and applications. NR is to be a unified network/system that is to meet vastly different and sometimes conflicting performance dimensions and services driven by different services and applications. As such, the complexity of such communication systems, as well as interactions between elements within a communication system, has increased. For example, the use of cryptographic algorithms as well as key usage under different conditions in wireless networks has become increasingly complex.

### BRIEF DESCRIPTION OF THE DRAWINGS

The present disclosure is illustrated by way of example and not limitation in the figures of the accompanying drawings, in which like references indicate similar elements and in which:

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates a method of cryptographic key use during access and mobility function (AMF) changes in accordance with some embodiments.

FIG. 4 illustrates a method for entropy-based cryptographic key selection in accordance with some embodiments.

FIG. 5 illustrates a method for uniform cryptographic key use during dual connectivity in accordance with some embodiments.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments outlined in the claims encompass all available equivalents of those claims.

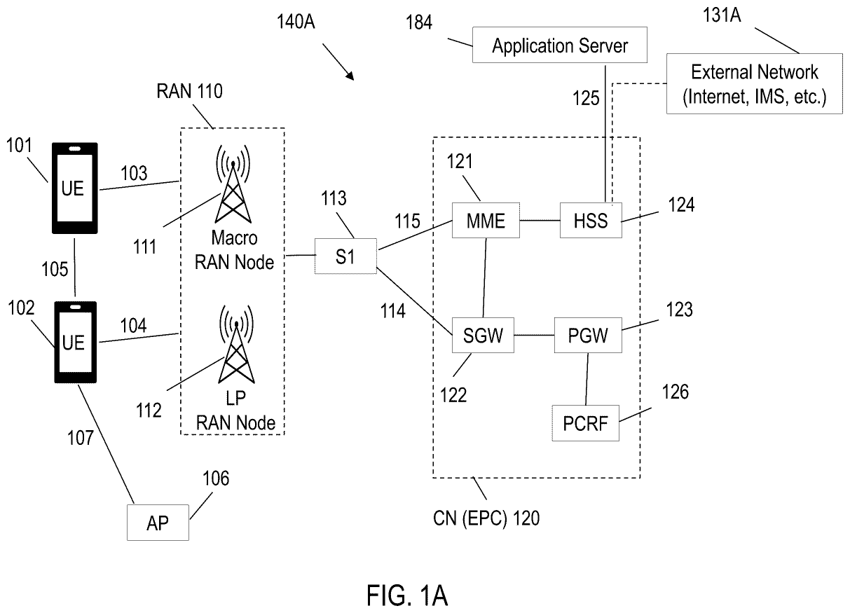

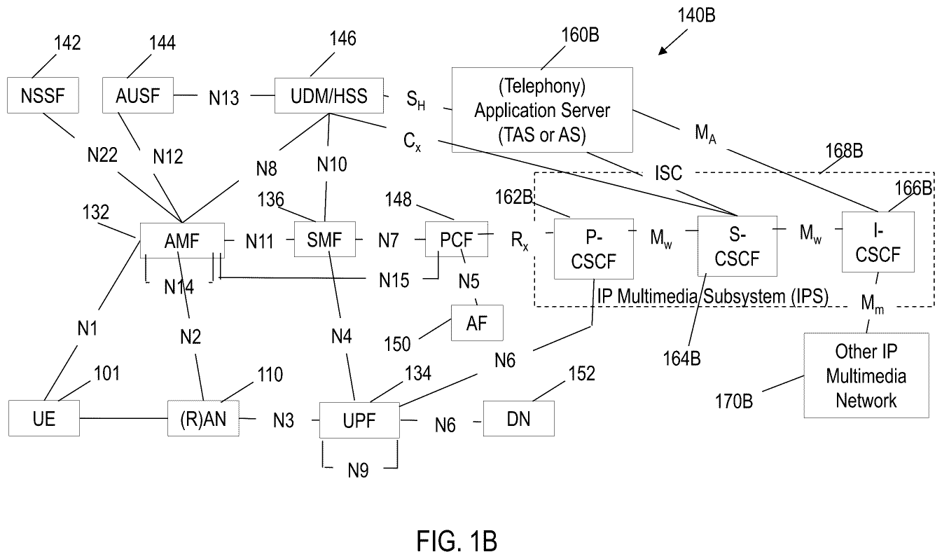

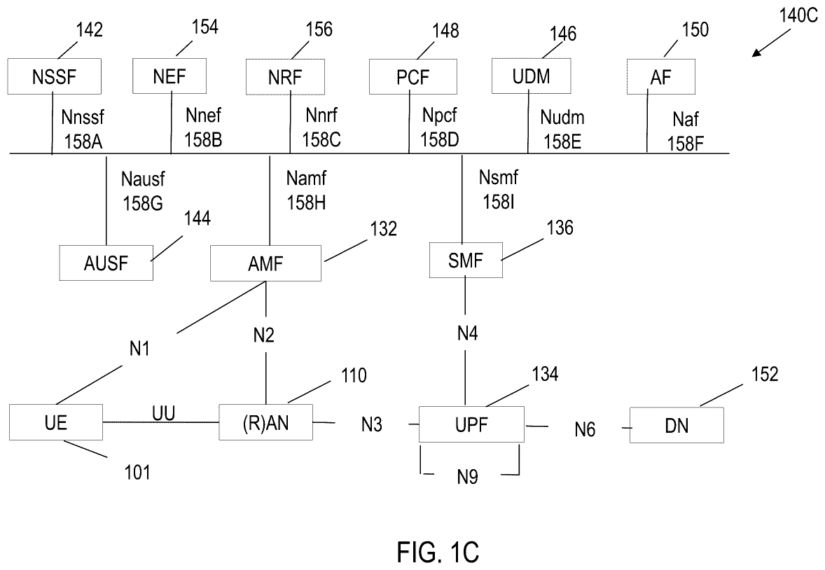

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a master node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

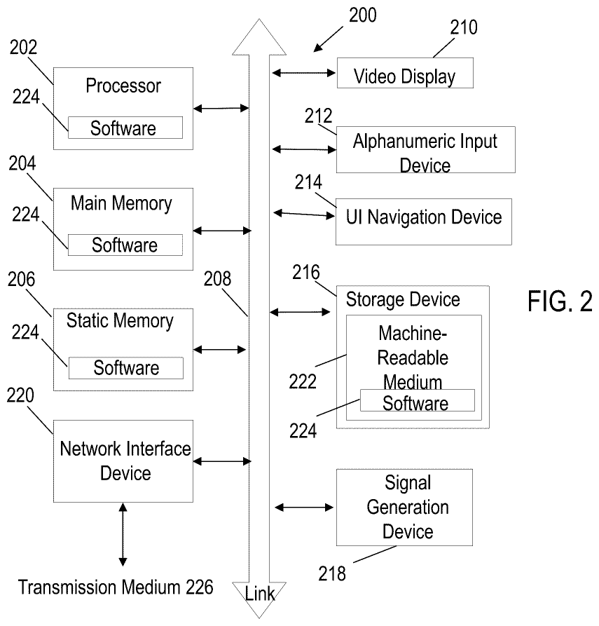

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth (r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHZ, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

As above, various advancements in cryptographic techniques within the context of 5G and future-generation wireless communication networks are described to tackle unique challenges associated with maintaining robust security protocols in increasingly complex network environments. A first of the advancements focuses on ensuring uniform cryptographic key lengths during AMF changes and reallocations. This solution introduces a protocol for managing and negotiating Non-Access Stratum (NAS) security contexts, ensuring that cryptographic key lengths remain consistent across different AMFs, thereby preserving the security integrity of user sessions during transitions. Another advancement addresses the complexities of dual connectivity scenarios, particularly in maintaining uniform cryptographic key lengths across Master Node (MN) and Secondary Node (SN) communications. As above, the MN and SN may be gNBs, for example. By defining a unified cryptographic profile and enhancing capability signaling, this ensures consistent key lengths are used, prioritizing the highest common cryptographic capability to meet security requirements. Another advancement introduces an entropy-based approach to cryptographic algorithm selection, ensuring that the security of cryptographic keys aligns with the actual entropy of long-term secrets. This method incorporates entropy assessment into the capability signaling process, ensuring that selected cryptographic algorithms for Access Stratum (AS) and NAS layers provide true security levels based on the entropy of the underlying keys. Together, these embodiments represent a comprehensive approach to enhancing cryptographic security in 5G networks, addressing challenges in key management, algorithm selection, and security context consistency across various network scenarios.

### Uniform Cryptographic Key Length

Several steps are involved to maintain a uniform cryptographic key length during AMF changes and reallocations. These steps include cryptographic capability storage and retrieval, security context anchoring, and uniform cryptographic key length negotiation. For cryptographic capability storage and retrieval, upon initial registration, the UE's cryptographic capabilities, including supported key lengths, are stored in the Security Anchor Function (SEAF). This information is retrieved during any subsequent AMF change or reallocation. For security context anchoring the SEAF anchors the NAS security context, ensuring that the cryptographic key length selected during initial registration is maintained across any AMF changes or reallocations. For uniform cryptographic key length negotiation during AMF change or reallocation, the target AMF consults the SEAF to determine the cryptographic key length to be used, ensuring uniformity across transitions.

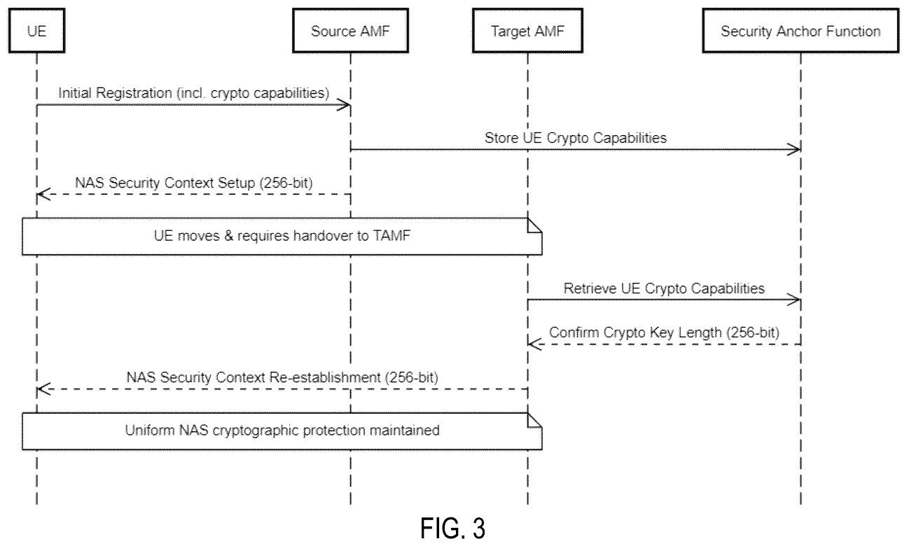

FIG. 3 illustrates a method of cryptographic key use during AMF changes in accordance with some embodiments. As shown, during initial registration, the UE signals its cryptographic capabilities, including the maximum supported key length (e.g., 256-bit), to a source AMF during the initial registration process. This information is forwarded by the source AMF to the SEAF, where at least the maximum supported key length is stored as part of the UE's security context. The SEAF is responsible for managing security contexts for a UE and thus plays a role in the authentication and key management processes. The SEAF acts as an intermediary between the UE and the Authentication Server Function (AUSF), facilitating the exchange of security credentials and ensuring that the cryptographic keys used for securing communications are properly anchored and managed. This function is used for maintaining the integrity and confidentiality of user data as it transitions between different network elements, such as during handovers or AMF changes.

During the NAS security context setup, the source AMF establishes the NAS security context based on the UE's capabilities and the network's policy, selecting the appropriate cryptographic key length (e.g., 256-bit) for NAS encryption and integrity protection. The NAS security context refers to the set of security parameters and cryptographic keys used to protect signaling messages exchanged between the UE and the core network. The NAS security context is established during the initial registration process and is maintained throughout the session to ensure the confidentiality, integrity, and authenticity of NAS signaling messages. The NAS security context includes information such as encryption and integrity protection algorithms, cryptographic keys, and other security-related parameters.

When the UE moves and a handover or AMF reallocation is initiated, the target AMF (TAMF) queries the SEAF to retrieve the UE's cryptographic capabilities and the previously established NAS security context, including the key length. A handover or reallocation to a target AMF in a 5G network can be triggered by several factors, primarily related to maintaining optimal connectivity and service quality for the UE. The network continuously monitors various parameters and conditions of the UE to decide when a handover or reallocation should take place. Some triggers for handover or reallocation include mobility events, load balancing, signal quality (e.g., signal strength such as Reference Signal Received Power (RSRP) or Received Signal Strength Indicator (RSSI) and/or signal quality Reference Signal Received Quality (RSRQ) or Signal-to-Interference-plus-Noise Ratio (SINR) from the serving cell and neighboring cells, bit error rate, timing advance), or policy and configuration changes. When a UE moves from one geographical area to another, it may enter a region served by a different AMF and trigger a handover to ensure continuous service. Alternatively, to manage network resources efficiently, a handover may be initiated to balance the load across different AMFs to help in optimizing network performance and preventing congestion. In some cases, if the signal quality from the current AMF degrades below a certain threshold, a handover to a target AMF with better signal quality may be triggered to maintain service quality. In addition, network policies or configuration updates may trigger a handover to a different AMF to align with new operational requirements or service agreements. In cases of network failures or scheduled maintenance, a handover may be triggered to reroute the UE to a functioning AMF to ensure uninterrupted service.

After the handover or reallocation is triggered, the target AMF may request the UE cryptographic capability information and the anchored NAS security context from the SEAF. Upon receiving the cryptographic capability information and the anchored NAS security context from the SEAF, the target AMF applies the same cryptographic key length (e.g., 256-bit) for NAS security context re-establishment, ensuring uniform cryptographic protection is maintained across the transition. This permits uniformity of the cryptographic key length used, notably when the source AMF and target AMF support different 3GPP generations (e.g., 5G and 6G).

### Entropy-Based Cryptographic Key Algorithm Selection

In addition to ensuring a uniform cryptographic key length between AMFs, enhanced security measures are desirable, particularly in the context of cryptographic key management and algorithm selection. Traditional approaches often overlook the entropy of long-term keys when selecting cryptographic algorithms, potentially compromising the security of communications.

Accordingly, a system and method that enhances the security mode control and capability signaling processes in 5G networks by incorporating entropy assessment of long-term secrets into the cryptographic algorithm selection process. This process ensures that the selected cryptographic algorithms for AS and NAS layers are only chosen if they align with the entropy level of the underlying long-term keys, thereby guaranteeing “true” security levels.

The issue of deriving 256-bit cryptographic keys from a 128-bit long-term secret, as highlighted in 3GPP TS 31.102, points to a fundamental security gap in achieving “true” 256-bit security. The challenge lies in ensuring that the derived keys for AS and NAS layers have sufficient entropy to match the security level of 256-bit cryptographic algorithms. Entropy-based solutions may be used to adjust Enhanced Capability Signaling with Anti-Bidding down Between Architectures (ABBA) Integration and Dynamic Selection Mechanism with ABBA Enforcement, in which an ABBA parameter is used to indicate security features that became insecure over time. The ABBA parameter is sent unprotected from the network to the UE.

“True” 256-bit security refers to the level of cryptographic security provided by a cryptographic key that has 256 bits of entropy. In cryptographic terms, entropy is a measure of the randomness or unpredictability of a key, which directly correlates to its strength against brute-force attacks. For a cryptographic key to provide “true” 256-bit security, it has 256 bits of entropy, meaning that there are 2²⁵⁶ possible combinations for the key. This level of entropy ensures that the key is sufficiently random and secure, making it practically infeasible for an attacker to guess or compute the key through exhaustive search methods.

Specifically, enhanced capability signaling may be used with entropy assessment. In this case, the capability signaling mechanism may be enhanced to include an assessment of the entropy of the long-term secret key stored in the Universal Subscriber Identity Module (USIM) and the UDM. This involves signaling the actual length and entropy level of the long-term key during initial security negotiations. The USIM is a type of smart card used in mobile devices to securely store the subscriber's identity and related information, such as authentication keys and network-specific data. This is followed by entropy verification, in which the network (specifically, the AUSF and UDM) verifies the entropy information of the long-term secret reported by the UE. This verification ensures that only keys with adequate entropy are used for deriving 256-bit AS and NAS keys.

Dynamic selection with entropy enforcement involves an entropy-based key derivation decision followed by a fallback mechanism. The former involves modifying the dynamic selection mechanism to include an entropy check as part of the decision-making process. This ensures that 256-bit cryptographic algorithms are selected only if the root keys (long-term secrets) have 256-bit entropy or higher. The latter involves implementing a fallback mechanism for scenarios where the long-term secret's entropy is insufficient for “true” 256-bit security. This mechanism may involve using the most secure available algorithm that matches the entropy of the root key or prompting an update of the long-term secret in the USIM, where feasible.

UE signaling, network verification and selection, and fallback and update is used to implement a solution. During the initial registration or security mode setup, the UE signals its cryptographic capabilities, including the entropy level of its long-term secret key. The network verifies the reported entropy level of the UE's long-term secret. Based on this verification, the network dynamically selects the appropriate cryptographic algorithm that matches the entropy level, ensuring the integrity and confidentiality of AS and NAS communications are not compromised. If the entropy level of the long-term secret is insufficient for the desired 256-bit cryptographic algorithms, the network either selects a secure alternative that matches the available entropy or initiates procedures to update the long-term secret in the USIM, subject to UE and network capabilities.

Various entities and protocols may be used to provide the solution. An entropy assessment module may be component within the UE and the AUSF designed to assess and report the entropy level of the long-term secret keys stored within the UE and UDM. An enhancement to the existing capability signaling protocol that includes entropy information of the long-term secret keys may be used as part of the initial security negotiations between the UE and the network. A dynamic cryptographic selection controller may implement control mechanism within the network, particularly within the AUSF, that dynamically selects the appropriate cryptographic algorithm for AS and NAS security based on the verified entropy level of the long-term secret keys and the cryptographic capabilities of the user equipment. A fallback mechanism may be used as a system protocol that initiates an alternative selection process or key update mechanism when the entropy level of the long-term secret is insufficient for the desired cryptographic algorithm.

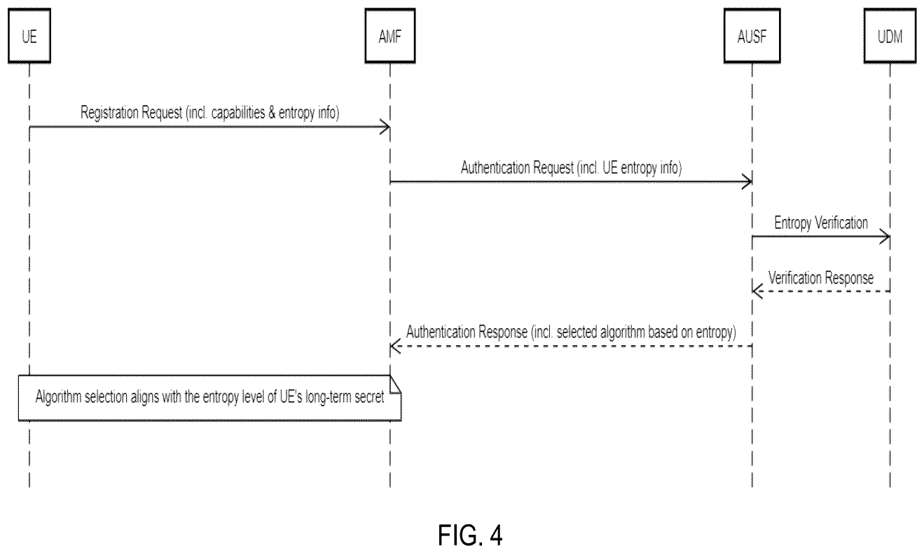

FIG. 4 illustrates a method for entropy-based cryptographic key selection in accordance with some embodiments. As shown in FIG. 4, upon initiating a security mode setup or registration request, the UE's Entropy Assessment Module evaluates the entropy of its long-term secret key and includes this information in the capability signaling message to the network. During the initial registration or security mode setup, the UE sends a capability signaling message to the network as part of the registration request process. This message includes information about the UE's cryptographic capabilities, such as supported encryption algorithms, key lengths, and other security-related parameters. The network uses this information to establish the appropriate security context and select suitable cryptographic algorithms for secure communication between the UE and the network. The capability signaling message may also include additional information, such as the entropy level of long-term secret keys, to ensure that the selected cryptographic algorithms align with the actual security level of the keys.

The AMF receives the registration request (which includes the cryptographic capabilities) and transmits an authentication request that includes the entropy information to the AUSF. The AUSF receives the capability signaling message, including the entropy information, and consults the Dynamic Cryptographic Selection Controller to verify the entropy level against the UDM's records and determine the appropriate cryptographic algorithm. Note that the UDM can also perform the actions of the Dynamic Cryptographic selection controller. Dynamic Cryptographic Selection Controller can be a virtual function inside UDM.

The UDM may provide to the AUSF a verification response that verifies the entropy level. The AUSF provides an authentication response to the AMF. The authentication response includes a selected cryptographic algorithm that matches the entropy level of the long-term secret key. The selected cryptographic algorithm is then communicated from the AMF back to the UE for implementation in AS and NAS security contexts.

If the entropy level is deemed insufficient for “true” 256-bit security, however, the fallback mechanism is engaged, either selecting the next best secure algorithm or triggering a process for updating the long-term secret key. The fallback mechanism may be implemented in the UDM.

Updating the long-term secret key in a UE may involve a coordinated process between the UE and the network, particularly the network's authentication and key management functions. The process may include triggering an update of the long-term secret key by various factors, such as a security policy change, detection of a compromised key, or insufficient entropy for the desired security level. The network, often through the AUSF or another relevant entity, initiates the key update process. This may involve sending a command or request to the UE to begin the update procedure. A secure communication channel is established between the UE and the network to ensure that the key update process is protected from eavesdropping or tampering. The network may generate a new long-term secret key or provide parameters for the UE to generate the key locally. This process ensures that the new key has sufficient entropy and meets the security requirements. The new key or key parameters are securely transmitted to the UE using encryption and integrity protection to safeguard the key during transmission. The UE securely stores the new long-term secret key in a secure element, such as the USIM, ensuring that it is protected from unauthorized access. The UE confirms the successful update of the long-term secret key to the network. The new key is then activated for use in subsequent authentication and encryption processes. The network and the UE synchronize their security contexts to ensure that both parties are using the updated key for future communications.

### Uniform Cryptographic Key Lengths in Dual Connectivity Scenarios

Dual Connectivity (DC) scenarios, especially with the transition to 256-bit cryptographic algorithms in 5G, introduce complexities in maintaining uniform cryptographic key lengths across MN and SN communications. Given the possibility of mixed deployment scenarios where MN and SN support different cryptographic capabilities, ensuring uniform cryptographic protection becomes a critical security requirement. Accordingly, it would be desirable to ensure that uniform cryptographic key lengths are used for both MN and SN in dual connectivity scenarios, regardless of their support for 256-bit cryptographic algorithms.

Several steps may be used to ensure that a uniform cryptographic key length is used in DC scenarios. A unified cryptographic profile may be defined for dual connectivity scenarios that mandates the use of consistent key lengths across MN and SN, prioritizing the highest common cryptographic capability.

The capability signaling mechanism may be extended to include detailed reporting of cryptographic capabilities (including supported key lengths) specific to dual connectivity scenarios. This signaling may occur during the dual connectivity setup and any subsequent reconfiguration phases.

A dynamic cryptographic selection mechanism may be implemented that, upon establishment or reconfiguration of dual connectivity, determines the highest common cryptographic key length supported by the UE, MN, and SN. In scenarios where the MN and SN support different cryptographic key lengths, the system may default to the highest key length supported by all parties, ensuring uniform security protection.

In addition, a fallback mechanism may be established for scenarios where uniform cryptographic key lengths cannot be achieved due to hardware limitations or configuration discrepancies. This mechanism may ensure that the communication remains protected at the highest possible security level without compromising the operational aspects of dual connectivity. A clear upgrade path may be implemented for RAN nodes to support 256-bit cryptographic algorithms, reducing the instances of mixed cryptographic capabilities.

Network-wide security policies that dictate the cryptographic key length requirements for dual connectivity scenarios may be developed and enforced. Network management systems may be equipped with the capability to dynamically adjust the cryptographic configuration of the MN and SN based on the unified cryptographic profile.

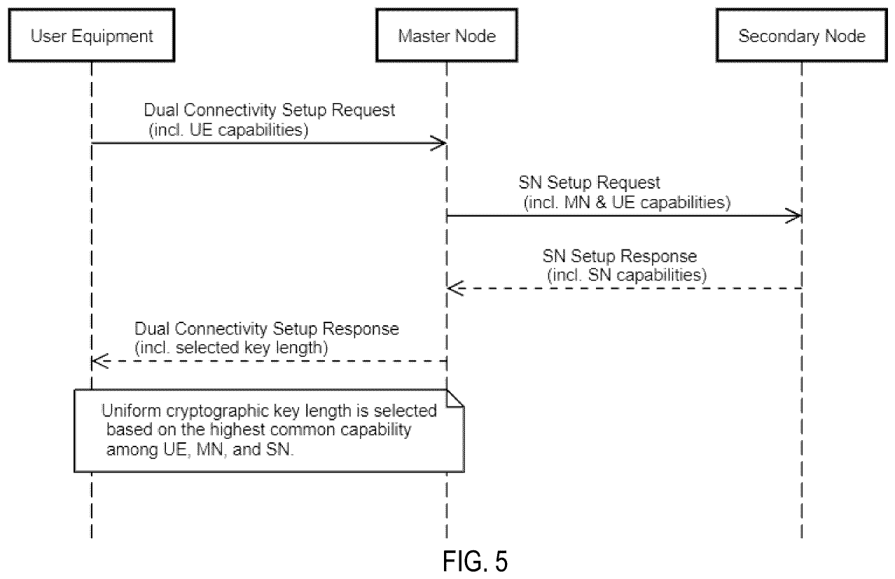

FIG. 5 illustrates a method for uniform cryptographic key use during dual connectivity in accordance with some embodiments. As shown in FIG. 5, the UE initiates a dual connectivity setup request with the MN, including the cryptographic capabilities of the UE. The cryptographic capabilities reported by the UE may include information about the encryption and integrity protection algorithms that the UE can support, details about the maximum supported cryptographic key lengths, and the entropy level of the UE's long-term secret keys to ensure that the selected cryptographic algorithms align with the actual security level of the keys.

The MN forwards a setup request to the SN. The setup request includes the cryptographic capabilities of both the MN and the UE.

The SN responds with its cryptographic capabilities, including supported key lengths.

The MN evaluates the cryptographic capabilities of all parties (UE, MN, SN) and selects the uniform cryptographic key length to be used across the dual connectivity setup. In other embodiments, the SN may determine the highest common cryptographic key length.

The MN informs the UE of the dual connectivity setup success, including the agreed-upon uniform cryptographic key length. The UE then uses the uniform cryptographic key length for communications with each of the master node and the secondary node (i.e., in AS and NAS security contexts for both the master node and the secondary node).

### EXAMPLES

Example 1 is an apparatus of a user equipment (UE), the apparatus comprising a processor that configures the apparatus to: send cryptographic capabilities to a network entity during initial registration or security mode setup, the cryptographic capabilities including at least one of supported key lengths and an entropy level of a long-term secret key; receive a response from the network entity, the response selected from a group of responses that include, a Non-Access Stratum (NAS) security context setup or re-establishment or dual connectivity setup, the response based on the cryptographic capabilities and network policies; and establish and maintain a NAS security context with the network entity based on the cryptographic capabilities.

In Example 2, the subject matter of Example 1 includes, wherein: the network entity is a source Access and Mobility Function (AMF); and the processor further configures the apparatus to: send the cryptographic capabilities to the source AMF during initial registration, the cryptographic capabilities including the supported key lengths; establish the NAS security context using a key length indicated by the source AMF and stored in a Security Anchor Function (SEAF); and in response to handover or reallocation to a target AMF, re-establish the NAS security context with the target AMF using the key length stored in the SEAF and determined by the target AMF.

In Example 3, the subject matter of Example 2 includes, wherein the cryptographic capabilities include a maximum supported key length, which is stored in the SEAF as part of the NAS security context.

In Example 4, the subject matter of Examples 1-3 includes, wherein: the network entity is an Access and Mobility Function (AMF); the cryptographic capabilities are sent to the AMF in a security mode setup or registration request, the cryptographic capabilities including the entropy level of the long-term secret key; the response from the AMF includes a cryptographic algorithm that matches the entropy level of the long-term secret key; and the processor further configures the apparatus to: evaluate the entropy level of the long-term secret key stored in the UE using an Entropy Assessment Module in the UE; and implement the cryptographic algorithm in an Access Stratum (AS) security context and the NAS security context.

In Example 5, the subject matter of Example 4 includes, wherein the cryptographic algorithm is determined by an authentication server function (AUSF).

In Example 6, the subject matter of Examples 1-5 includes, wherein: the network entity is an Access and Mobility Function (AMF); the cryptographic capabilities are sent to the AMF in a security mode setup or registration request, the cryptographic capabilities including the entropy level of the long-term secret key; the response from the AMF includes a cryptographic algorithm that matches the entropy level of the long-term secret key but is insufficient for 256-bit security; and the processor further configures the apparatus to implement the cryptographic algorithm in an Access Stratum (AS) security context and the NAS security context.

In Example 7, the subject matter of Examples 1-6 includes, wherein: the network entity is an Access and Mobility Function (AMF); the cryptographic capabilities are sent to the AMF in a security mode setup or registration request, the cryptographic capabilities including the entropy level of the long-term secret key; the response includes a request for the UE to update the long-term secret key due to the entropy level of the long-term secret key being insufficient for 256-bit security; and the processor further configures the apparatus to: update the long-term secret key in response to reception of the response from the AMF to obtain an updated long-term secret key that is sufficient for 256-bit security; and implement a cryptographic algorithm in an Access Stratum (AS) security context and the NAS security context using the updated long-term secret key.

In Example 8, the subject matter of Examples 1-7 includes, wherein: the network entity is a master node; the cryptographic capabilities are sent to the master node in a dual connectivity setup request; the response includes an indication of dual connectivity setup success and a cryptographic key length that is to be used for communications with the master node and a secondary node; and the processor further configures the apparatus to, in response to reception of the cryptographic key length, use the cryptographic key length for communications with the master node and a secondary node.

In Example 9, the subject matter of Example 8 includes, wherein the cryptographic key length defaults to a highest key length supported by the UE, the master node, and the secondary node in scenarios in which the master node and the secondary node support different cryptographic key lengths.

In Example 10, the subject matter of Examples 8-9 includes, wherein the cryptographic capabilities are received by the master node in capability signaling that is transmitted by the UE to the master node during dual connectivity setup and any subsequent reconfiguration phases.

Example 11 is an apparatus of a network entity, the apparatus comprising a processor that configures the apparatus to: receive cryptographic capabilities from a user equipment (UE) during initial registration or security mode setup, the cryptographic capabilities including at least one of supported key lengths and an entropy level of a long-term secret key; transmit a response to the UE, the response selected from a group of responses that include, a Non-Access Stratum (NAS) security context setup or re-establishment or dual connectivity setup, the response based on the cryptographic capabilities and network policies; and establish and maintain a NAS security context with the UE based on the cryptographic capabilities.

In Example 12, the subject matter of Example 11 includes, wherein: the network entity is a source Access and Mobility Function (AMF); the processor further configures the apparatus to: receive the cryptographic capabilities during initial registration of the UE, the cryptographic capabilities including the supported key lengths and a maximum supported key length; and send the cryptographic capabilities to a Security Anchor Function (SEAF) for storage for retrieval by a target AMF and re-establishment of the NAS security context by the target AMF with the UE during handover or reallocation of the UE to the target AMF; and establish the NAS security context using a key length indicated to the UE, the key length also used by the target AMF.

In Example 13, the subject matter of Examples 11-12 includes, wherein: the network entity is an Access and Mobility Function (AMF); the cryptographic capabilities are received by the AMF in a security mode setup or registration request, the cryptographic capabilities including the entropy level of the long-term secret key; the response from the AMF includes a cryptographic algorithm that matches the entropy level of the long-term secret key; and the processor further configures the apparatus to: in response to reception of the security mode setup or registration request, send an authentication request including the cryptographic capabilities to an authentication server function (AUSF) to verify the entropy level against records in a unified data management (UDM) records and determine the cryptographic algorithm; receive an authentication response from the AUSF containing the cryptographic algorithm; and implement the cryptographic algorithm in an Access Stratum (AS) security context and the NAS security context.

In Example 14, the subject matter of Examples 11-13 includes, wherein: the network entity is an Access and Mobility Function (AMF); the cryptographic capabilities are received by the AMF in a security mode setup or registration request, the cryptographic capabilities including the entropy level of the long-term secret key; the response from the AMF includes a cryptographic algorithm matches the entropy level of the long-term secret key but is insufficient for 256-bit security; and the processor further configures the apparatus to: in response to reception of the security mode setup or registration request, send an authentication request including the cryptographic capabilities to an authentication server function (AUSF) to verify the entropy level against records in a unified data management (UDM) records and dynamically select the cryptographic algorithm based on the long-term secret key; receive an authentication response from the AUSF containing the cryptographic algorithm, the cryptographic algorithm selected in response to the entropy level of the long-term secret key being insufficient for 256-bit security; and implement the cryptographic algorithm in an Access Stratum (AS) security context and the NAS security context.

In Example 15, the subject matter of Examples 11-14 includes, wherein: the network entity is an Access and Mobility Function (AMF); the cryptographic capabilities are received by the AMF in a security mode setup or registration request, the cryptographic capabilities including the entropy level of the long-term secret key; the response includes a request for the UE to update the long-term secret key due to the entropy level of the long-term secret key being insufficient for 256-bit security; and the processor further configures the apparatus to: in response to reception of the security mode setup or registration request, send an authentication request including the cryptographic capabilities to an authentication server function (AUSF) to verify the entropy level against records in a unified data management (UDM) records and determine a cryptographic algorithm; receive an authentication response from the AUSF containing an instruction for the UE to update the long-term secret key due to the entropy level of the long-term secret key being insufficient for 256-bit security; and engage in an update process with the UE to update the long-term secret key in response to sending the response to the UE.

In Example 16, the subject matter of Examples 11-15 includes, wherein: the network entity is a master node; the cryptographic capabilities are received by the master node in a dual connectivity setup request; the response includes an indication of dual connectivity setup success and a cryptographic key length that is to be used for communications with the master node and a secondary node; and the processor further configures the apparatus to, in response to reception of the dual connectivity setup request: forward the dual connectivity setup request to the secondary node along with cryptographic capabilities of the master node for the secondary node; receive, from the secondary node, a response with cryptographic capabilities that includes supported key lengths of the secondary node; determine a highest common cryptographic key length among the UE, the master node, and the secondary node; and use the cryptographic key length for communications with the UE.

In Example 17, the subject matter of Example 16 includes, wherein the cryptographic key length defaults to a highest key length supported by the UE, the master node, and the secondary node in scenarios in which the master node and the secondary node support different cryptographic key lengths.

Example 18 is a non-transitory computer-readable storage medium that stores instructions for execution by one or more processors of an apparatus of a user equipment (UE), the instructions, when executed, configured to cause the apparatus to: send cryptographic capabilities to a network entity during initial registration or security mode setup, the cryptographic capabilities including at least one of supported key lengths and an entropy level of a long-term secret key; receive a response from the network entity, the response selected from a group of responses that include, a Non-Access Stratum (NAS) security context setup or re-establishment or dual connectivity setup, the response based on the cryptographic capabilities and network policies; and establish and maintain a NAS security context with the network entity based on the cryptographic capabilities.

In Example 19, the subject matter of Example 18 includes, wherein: the network entity is a source Access and Mobility Function (AMF); and the instructions, when executed, configure the apparatus to: send the cryptographic capabilities to the source AMF during initial registration, the cryptographic capabilities including the supported key lengths; establish the NAS security context using a key length indicated by the source AMF and stored in a Security Anchor Function (SEAF); and in response to handover or reallocation to a target AMF, re-establish the NAS security context with the target AMF using the key length stored in the SEAF and determined by the target AMF.

In Example 20, the subject matter of Examples 18-19 includes, wherein the instructions, when executed, configure the apparatus to: the network entity is an Access and Mobility Function (AMF); the cryptographic capabilities are sent to the AMF in a security mode setup or registration request, the cryptographic capabilities including the entropy level of the long-term secret key; the response from the AMF includes a cryptographic algorithm that matches the entropy level of the long-term secret key; and the instructions, when executed, configure the apparatus to: evaluate the entropy level of the long-term secret key stored in the UE using an Entropy Assessment Module in the UE; and implement the cryptographic algorithm in an Access Stratum (AS) security context and the NAS security context.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus of a user equipment (UE), the apparatus comprising a processor that configures the apparatus to:
send cryptographic capabilities to a network entity during initial registration or security mode setup, the cryptographic capabilities including at least one of supported key lengths and an entropy level of a long-term secret key;
receive a response from the network entity, the response selected from a group of responses that include a Non-Access Stratum (NAS) security context setup or re-establishment or dual connectivity setup, the response based on the cryptographic capabilities and network policies; and
establish and maintain a NAS security context with the network entity based on the cryptographic capabilities.

2. The apparatus of claim 1, wherein:
the network entity is a source Access and Mobility Function (AMF); and
the processor further configures the apparatus to:
send the cryptographic capabilities to the source AMF during initial registration, the cryptographic capabilities including the supported key lengths;
establish the NAS security context using a key length indicated by the source AMF and stored in a Security Anchor Function (SEAF); and
in response to handover or reallocation to a target AMF, re-establish the NAS security context with the target AMF using the key length stored in the SEAF and determined by the target AMF.

3. The apparatus of claim 2, wherein the cryptographic capabilities include a maximum supported key length, which is stored in the SEAF as part of the NAS security context.

4. The apparatus of claim 1, wherein:
the network entity is an Access and Mobility Function (AMF);
the cryptographic capabilities are sent to the AMF in a security mode setup or registration request, the cryptographic capabilities including the entropy level of the long-term secret key;
the response from the AMF includes a cryptographic algorithm that matches the entropy level of the long-term secret key; and
the processor further configures the apparatus to:
evaluate the entropy level of the long-term secret key stored in the UE using an Entropy Assessment Module in the UE; and
implement the cryptographic algorithm in an Access Stratum (AS) security context and the NAS security context.

5. The apparatus of claim 4, wherein the cryptographic algorithm is determined by an authentication server function (AUSF).

6. The apparatus of claim 1, wherein:
the network entity is an Access and Mobility Function (AMF);
the cryptographic capabilities are sent to the AMF in a security mode setup or registration request, the cryptographic capabilities including the entropy level of the long-term secret key;
the response from the AMF includes a cryptographic algorithm that matches the entropy level of the long-term secret key but is insufficient for 256-bit security; and
the processor further configures the apparatus to implement the cryptographic algorithm in an Access Stratum (AS) security context and the NAS security context.

7. The apparatus of claim 1, wherein:
the network entity is an Access and Mobility Function (AMF);
the cryptographic capabilities are sent to the AMF in a security mode setup or registration request, the cryptographic capabilities including the entropy level of the long-term secret key;
the response includes a request for the UE to update the long-term secret key due to the entropy level of the long-term secret key being insufficient for 256-bit security; and
the processor further configures the apparatus to:
update the long-term secret key in response to reception of the response from the AMF to obtain an updated long-term secret key that is sufficient for 256-bit security; and
implement a cryptographic algorithm in an Access Stratum (AS) security context and the NAS security context using the updated long-term secret key.

8. The apparatus of claim 1, wherein:
the network entity is a master node;
the cryptographic capabilities are sent to the master node in a dual connectivity setup request;
the response includes an indication of dual connectivity setup success and a cryptographic key length that is to be used for communications with the master node and a secondary node; and
the processor further configures the apparatus to, in response to reception of the cryptographic key length, use the cryptographic key length for communications with the master node and a secondary node.

9. The apparatus of claim 8, wherein the cryptographic key length defaults to a highest key length supported by the UE, the master node, and the secondary node in scenarios in which the master node and the secondary node support different cryptographic key lengths.

10. The apparatus of claim 8, wherein the cryptographic capabilities are received by the master node in capability signaling that is transmitted by the UE to the master node during dual connectivity setup and any subsequent reconfiguration phases.

11. An apparatus of a network entity, the apparatus comprising a processor that configures the apparatus to:
receive cryptographic capabilities from a user equipment (UE) during initial registration or security mode setup, the cryptographic capabilities including at least one of supported key lengths and an entropy level of a long-term secret key;
transmit a response to the UE, the response selected from a group of responses that include a Non-Access Stratum (NAS) security context setup or re-establishment or dual connectivity setup, the response based on the cryptographic capabilities and network policies; and
establish and maintain a NAS security context with the UE based on the cryptographic capabilities.

12. The apparatus of claim 11, wherein:
the network entity is a source Access and Mobility Function (AMF);
the processor further configures the apparatus to:
receive the cryptographic capabilities during initial registration of the UE, the cryptographic capabilities including the supported key lengths and a maximum supported key length; and
send the cryptographic capabilities to a Security Anchor Function (SEAF) for storage for retrieval by a target AMF and re-establishment of the NAS security context by the target AMF with the UE during handover or reallocation of the UE to the target AMF; and
establish the NAS security context using a key length indicated to the UE, the key length also used by the target AMF.

13. The apparatus of claim 11, wherein:
the network entity is an Access and Mobility Function (AMF);
the cryptographic capabilities are received by the AMF in a security mode setup or registration request, the cryptographic capabilities including the entropy level of the long-term secret key;
the response from the AMF includes a cryptographic algorithm that matches the entropy level of the long-term secret key; and
the processor further configures the apparatus to:
in response to reception of the security mode setup or registration request, send an authentication request including the cryptographic capabilities to an authentication server function (AUSF) to verify the entropy level against records in a unified data management (UDM) records and determine the cryptographic algorithm;
receive an authentication response from the AUSF containing the cryptographic algorithm; and
implement the cryptographic algorithm in an Access Stratum (AS) security context and the NAS security context.

14. The apparatus of claim 11, wherein:
the network entity is an Access and Mobility Function (AMF);
the cryptographic capabilities are received by the AMF in a security mode setup or registration request, the cryptographic capabilities including the entropy level of the long-term secret key;
the response from the AMF includes a cryptographic algorithm matches the entropy level of the long-term secret key but is insufficient for 256-bit security; and
the processor further configures the apparatus to:
in response to reception of the security mode setup or registration request, send an authentication request including the cryptographic capabilities to an authentication server function (AUSF) to verify the entropy level against records in a unified data management (UDM) records and dynamically select the cryptographic algorithm based on the long-term secret key;
receive an authentication response from the AUSF containing the cryptographic algorithm, the cryptographic algorithm selected in response to the entropy level of the long-term secret key being insufficient for 256-bit security; and
implement the cryptographic algorithm in an Access Stratum (AS) security context and the NAS security context.

15. The apparatus of claim 11, wherein:
the network entity is an Access and Mobility Function (AMF);
the cryptographic capabilities are received by the AMF in a security mode setup or registration request, the cryptographic capabilities including the entropy level of the long-term secret key;
the response includes a request for the UE to update the long-term secret key due to the entropy level of the long-term secret key being insufficient for 256-bit security; and
the processor further configures the apparatus to:
in response to reception of the security mode setup or registration request, send an authentication request including the cryptographic capabilities to an authentication server function (AUSF) to verify the entropy level against records in a unified data management (UDM) records and determine a cryptographic algorithm;
receive an authentication response from the AUSF containing an instruction for the UE to update the long-term secret key due to the entropy level of the long-term secret key being insufficient for 256-bit security; and
engage in an update process with the UE to update the long-term secret key in response to sending the response to the UE.

16. The apparatus of claim 11, wherein:
the network entity is a master node;
the cryptographic capabilities are received by the master node in a dual connectivity setup request;
the response includes an indication of dual connectivity setup success and a cryptographic key length that is to be used for communications with the master node and a secondary node; and
the processor further configures the apparatus to, in response to reception of the dual connectivity setup request:
forward the dual connectivity setup request to the secondary node along with cryptographic capabilities of the master node for the secondary node;
receive, from the secondary node, a response with cryptographic capabilities that includes supported key lengths of the secondary node;
determine a highest common cryptographic key length among the UE, the master node, and the secondary node; and
use the cryptographic key length for communications with the UE.

17. The apparatus of claim 16, wherein the cryptographic key length defaults to a highest key length supported by the UE, the master node, and the secondary node in scenarios in which the master node and the secondary node support different cryptographic key lengths.

18. A non-transitory computer-readable storage medium that stores instructions for execution by one or more processors of an apparatus of a user equipment (UE), the instructions, when executed, configured to cause the apparatus to:
send cryptographic capabilities to a network entity during initial registration or security mode setup, the cryptographic capabilities including at least one of supported key lengths and an entropy level of a long-term secret key;
receive a response from the network entity, the response selected from a group of responses that include a Non-Access Stratum (NAS) security context setup or re-establishment or dual connectivity setup, the response based on the cryptographic capabilities and network policies; and
establish and maintain a NAS security context with the network entity based on the cryptographic capabilities.

19. The non-transitory computer-readable storage medium of claim 18, wherein:
the network entity is a source Access and Mobility Function (AMF); and
the instructions, when executed, configure the apparatus to:
send the cryptographic capabilities to the source AMF during initial registration, the cryptographic capabilities including the supported key lengths;
establish the NAS security context using a key length indicated by the source AMF and stored in a Security Anchor Function (SEAF); and
in response to handover or reallocation to a target AMF, re-establish the NAS security context with the target AMF using the key length stored in the SEAF and determined by the target AMF.

20. The non-transitory computer-readable storage medium of claim 18, wherein the instructions, when executed, configure the apparatus to:
the network entity is an Access and Mobility Function (AMF);
the cryptographic capabilities are sent to the AMF in a security mode setup or registration request, the cryptographic capabilities including the entropy level of the long-term secret key;
the response from the AMF includes a cryptographic algorithm that matches the entropy level of the long-term secret key; and
the instructions, when executed, configure the apparatus to:
evaluate the entropy level of the long-term secret key stored in the UE using an Entropy Assessment Module in the UE; and
implement the cryptographic algorithm in an Access Stratum (AS) security context and the NAS security context.
